(19) United States
(12) Patent Application Publication
(10) Pub. No.: US 2022/0407426 A1
(43) Pub. Date: Dec. 22, 2022

(54) POWER CONVERTER AND METHOD FOR CONTROLLING POWER CONVERTER

(71) Applicant: APERD Corporation, Nagoya-shi (JP)

(72) Inventor: Takaharu TAKESHITA, Nagoya-shi (JP)

(21) Appl. No.: 17/778,349

(22) PCT Filed: Nov. 20, 2020
(86) PCT No.: PCT/JP2020/043503

§ 371 Date: May 19, 2022

(30) Foreign Application Priority Data
Nov. 22, 2019 (JP) 2019-211006

(51) Int. Cl. H02M 3/335; H02M 1/08; H02M 1/00

(52) U.S. Cl. CPC H02M 3/33571; H02M 3/33584; H02M 1/08; H02M 1/0054

(57) ABSTRACT

[Problem] To provide a single-direction insulative DC-DC power converter using a single-direction switch circuit capable of realizing soft switching even with a simple circuit configuration and a method for controlling the DC-DC power converter. [Solution] A power converter comprising a primary circuit and a secondary circuit connected via a high-frequency transformer, wherein a circuit having a switching element is provided to the primary circuit, the secondary circuit has, connected in parallel, a DC capacitor and a diode rectifying circuit including four diodes U+, U−, V+, and V− each having a resonance capacitor Cᵣ connected in parallel, and a resonance circuit formed by the resonance capacitor Cᵣ and a leakage inductance L of a the high-frequency transformer is formed in the secondary circuit.

### BACKGROUND

### Technical Field

The present disclosure relates to a power converter, and more particularly, to a power converter capable of conducting and interrupting current in a single direction using a bi-directional switch circuit, and a control method thereof.

### Description of the Related Art

A circuit configuration of a known DC-DC power converter includes the following: (1) A circuit configuration with a diode rectification circuit and a DC capacitor connected to a secondary side of a high-frequency transformer (e.g., FIG. 2(a) in Non Patent Literature 1)
(2) A circuit configuration with a reactor inserted into output of a secondary side diode rectification circuit (FIG. 1, etc., in Patent Literature 1)
(3) A circuit configuration adopting an LLC converter with a capacitor connected in series to a primary side (e.g., FIG. 1, etc., in Patent Literature 2)

### CITATION LIST

### Non Patent Literature

Non Patent Literature 1: R. W. D. Doncker, D. M. Divan, and M. H. Kheraluwala: “A three-phase soft-switched high-power-density dc/dc converter for high-power applications,” IEEE Trans. Ind. Appl., Vol. 27, No. 1, pp. 63-73, 1991. (FIG. 2(a) in particular)

### PATENT LITERATURE

Patent Literature 1: Japanese Patent Application Laid-Open No. 2014-233121 (FIG. 1 in particular)

Patent Literature 2: Japanese Patent Application Laid-Open No. 2017-204972 (FIG. 1 in particular)

### BRIEF SUMMARY

### Technical Problem

However, a problem with the circuit configuration as shown in (1) above is that the high-frequency transformer has a low voltage utilization rate and when the turn ratio of the transformer is 1, the DC voltage on the secondary side becomes lower than that on the primary side. With the circuit configuration as shown in (2) above, a leakage inductance of the transformer at the time of switching and a parasitic capacitance of the diode of the diode rectification circuit may generate a surge voltage due to LC resonance and destroy the switching element. Practically, it is necessary to prevent the generation of surge voltage or prevent the destruction of the switching element, which leads to a complicated circuit configuration. With the circuit configuration as shown in (3) above, the primary side voltage needs to be controlled to control the resonance frequency. That is, it is necessary not only to follow the resonance frequency as parameters change but also to perform precise control, which is not desirable from the standpoint of controllability.

An object of the present disclosure, which has been made in view of the above problems, is to provide a unidirectional insulated DC-DC power converter using a unidirectional switch circuit capable of realizing soft switching even with a simple circuit configuration and a control method thereof.

### Solution to Problem

A first embodiment of the present disclosure is a DC-DC converter including an H bridge circuit on a primary side and a transformer and a diode rectification circuit on a secondary side, adopting a circuit configuration in which a capacitor is connected in parallel to each diode of the secondary side diode rectification circuit to make LC resonance with a leakage inductance of the transformer at the time of diode commutation.

More specifically, the power converter according to the present disclosure is configured as follows:

A power converter including a primary circuit and a secondary circuit connected via a transformer, in which
the primary circuit is provided with a circuit having a switching element,
the secondary circuit is provided with a diode rectification circuit including four diodes (U+, U−, V+, V−) each having a resonance capacitor (Cᵣ) connected in parallel, and a smoothing capacitor (C2) connected in parallel, and
in the secondary circuit, a resonance circuit is formed by a leakage inductance (L) of the transformer and the resonance capacitor (Cᵣ).

According to such a configuration, the switching element of the primary circuit can be soft-switched and losses can be reduced.

Here, “soft switching” refers to switching that is performed when zero voltage or zero current, and ZVS (zero voltage switching) performed with zero voltage is preferably used.

Note that as the transformer, a high-frequency transformer for frequencies higher than commercial power frequencies is preferably used. Using the high-frequency transformer, the circuit can be configured in small size.

According to such a configuration, it is possible to smoothly achieve sign inversion of current and independently select the frequency of the (high frequency) transformer as a frequency slower than a resonance frequency.

Since the resonance frequency can be set higher than the frequency of the (high frequency) transformer, it is possible to make the resonance capacitor or inductor smaller compared with, for example, an LLC converter, and there is an advantage that the circuit can be made smaller.

### BRIEF DESCRIPTION OF THE SEVERAL VIEWS OF THE DRAWINGS

FIG. 1 is a circuit diagram of a power converter according to a first embodiment.

FIG. 2 is a diagram illustrating a conducting state of each switch, and voltage and current waveforms of a high-frequency transformer.

FIG. 3 is a diagram illustrating each commutation operation of a secondary side diode rectification circuit.

FIG. 4 is a diagram illustrating characteristics of output power Pout versus a ratio fₛ/fₒ of a frequency of the high-frequency transformer to a resonance frequency.

FIG. 5 is a diagram illustrating operating modes of a primary circuit and a primary voltage waveform v₁ of the high-frequency transformer when a switch R− or S+ is commutated to a switch R+ or S− of the primary circuit.

FIG. 6 is a circuit diagram of a power converter according to a second embodiment.

FIG. 7 is an operating waveform diagram illustrating a method for controlling output power according to mode switching timing (mode 2-2).

FIG. 8 is an operating waveform diagram illustrating a method for controlling output power according to mode switching timing (mode 2-3).

FIG. 9 is an output power characteristic diagram versus a period Td during which the primary voltage v₁ is zero.

### DETAILED DESCRIPTION

Hereinafter, embodiments of the present disclosure will be described with reference to the accompanying drawings. However, none of the following embodiments is intended to limit the recognition of the gist of the present disclosure. Moreover, the same reference numerals may be used for the same or similar components and description thereof may be omitted.

Note that, for example, an H-bridge circuit or a half bridge circuit may be used for the soft switching circuit of the primary circuit, but without being limited to this, any circuit can be used.

### Basic Conception of Present Disclosure

A basic circuit configuration of the present disclosure is characterized by the use of a unidirectional insulated DC-DC power converter adopting a circuit configuration in which a primary circuit for generating square wave or the like by a circuit provided with a switching element and a secondary circuit configured only of passive elements and constructed by combining a rectification circuit and an LC resonance circuit, and the primary and secondary circuits are electromagnetically coupled by a transformer. Although it is a simple circuit configuration, supply power can be adjusted by a switching frequency of the primary circuit and the secondary circuit side is constructed only of passive elements, and so there is an advantage that the primary circuit side and the secondary circuit side can be separated by an iron core of the transformer. Hereinafter, a specific circuit diagram will be described with reference to the accompanying drawings.

### First Embodiment

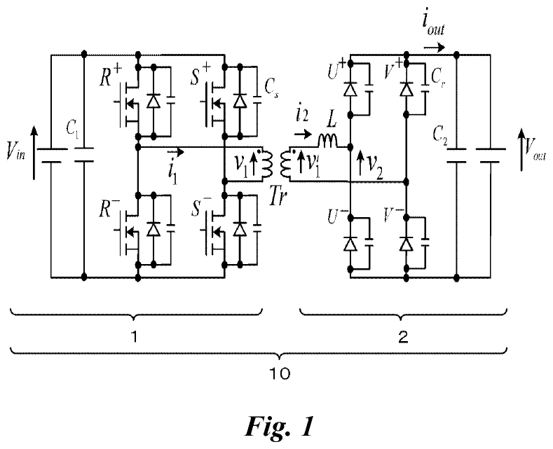

FIG. 1 illustrates a circuit diagram of a power converter (10) of a first embodiment. The present circuit is a unidirectional insulated DC-DC power converter, an H-bridge circuit is provided on a primary circuit (1) side, a secondary circuit (2) side is constructed of a diode rectification circuit, and the primary and secondary circuits are coupled by a high-frequency transformer Tr. Note that the primary circuit and the secondary circuit may be simply denoted as “primary side” and “secondary side” respectively. The high-frequency transformer Tr may be simply denoted as “transformer.”

The primary side H-bridge circuit is constructed of four switching elements R+, R−, S+ and S−. An antiparallel diode is connected to each switching element. A parasitic capacitance (stray capacitance) of the switching element is denoted as Cs. The primary side H-bridge circuit converts an input DC voltage Vᵢₙ to a high-frequency square wave AC voltage v₁.

Note that a leakage inductance of the high-frequency transformer Tr is denoted as L, a leakage inductance of the entire high-frequency transformer is denoted as a converted value on the secondary side. When the leakage inductance is small, a reactor is connected in series to the transformer, and the leakage inductance L (inductance L) includes a leakage inductance of the high-frequency transformer itself and the inserted reactor. When the numbers of turns of the primary wiring and the secondary wiring of the transformer are defined as n1 and n2 respectively, a secondary converted value of the primary voltage v₁ is denoted as v₁′ (=v₁/a) using a turn ratio a (=n1/n2).

The secondary side diode rectification circuit is constructed of four diodes U+, U−, V+ and V− with a resonance capacitor Cᵣ connected in parallel to each other, and a smoothing capacitor C2. The capacitance of the resonance capacitor Cᵣ is a substantially large value (e.g., several tens of nF to 1 μF (F, more specifically, 100 nF to 1 μF, typically 500 nF to 1 μF) relative to the parasitic capacitance of the diode (e.g., on the order of several nF to 10 nF). The secondary side diode rectification circuit converts a high-frequency square wave voltage to an output DC voltage Vₒᵤₜ.

Note that by using a diode with a sufficiently large parasitic capacitance (e.g., several tens of nF to 1 μF) (diode designed to have a larger capacity), it is also possible to adopt a configuration in which the resonance capacitor Cᵣ is substantially incorporated in the diode. In this case, the resonance capacitor Cᵣ need not be provided outside the diode and can be configured in a small size.

The secondary circuit shown in the present embodiment is characterized by the use of resonance between the inductance L and the capacitor Cᵣ, and other configurations can be changed as appropriate depending on the application. Although a DC power supply is connected to the secondary side output, for example, in FIG. 1, a DC load may also be connected. In an application as a charging circuit for the secondary battery, it is denoted as a DC power supply as shown, for example, in FIG. 1, whereas when it is used as a DC-DC converter when power is converted, for example, from overhead rail lines to railroad, it is denoted as a DC load.

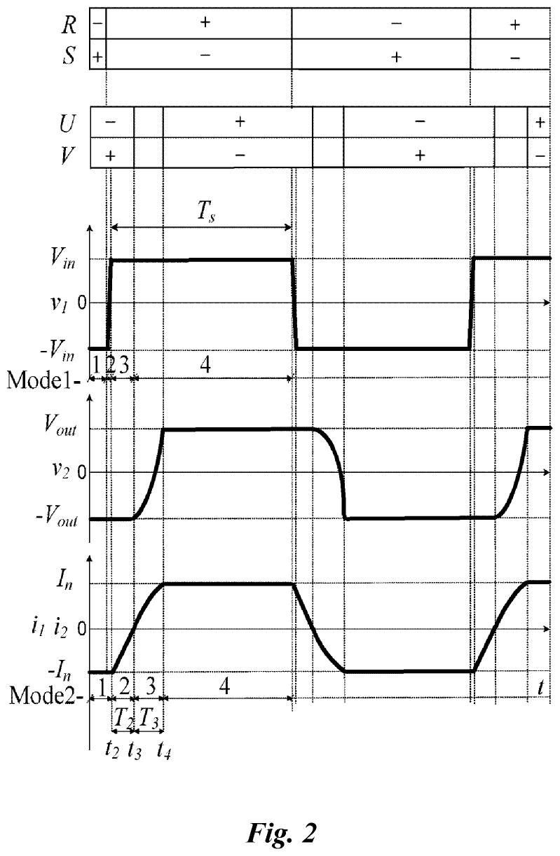

FIG. 2 illustrates a conducting state of each switch of the isolated DC-DC power conversion circuit shown in FIG. 1, and voltage and current waveforms of the high-frequency transformer. The horizontal axis in FIG. 2 represents time. For simplicity of description, FIG. 2 shows a case where a=1, where “a” is assumed to be the turn ratio of the high-frequency transformer and further Vᵢₙ=Vₒᵤₜ assuming that input and output DC voltages are equal. In the primary side H-bridge circuit, by shifting switching phases of R and S phases 180 degrees and energizing each switch with a duty of 50%, a square wave AC voltage having amplitude of the input DC voltage Vᵢₙ and a frequency fₛ (=1/2 Tₛ; half cycle Tₛ of the high-frequency waveform) is generated as the primary voltage v₁. In the waveform of the primary voltage v₁ in FIG. 2, periods from <mode 1-1> to <mode 1-4> are shown as operating modes due to changes in the primary voltage v₁. The secondary voltage v₂ is a voltage delayed with respect to the primary voltage v₁. If an excitation current of the high-frequency transformer is ignored assuming that it is sufficiently small compared with the primary and secondary currents, a primary current i₁ and a secondary current i₂ of the high-frequency transformer are equal. Square wave currents shown in FIG. 2 as the primary current i₁ and the secondary current i₂ are obtained. Details of the waveforms will be derived in detail later. Periods from <mode 2-1> to <mode 2-4> are shown as operating modes due to commutation of the secondary side diode rectification circuit together with the waveforms of the primary current i₁ and the secondary current i₂.

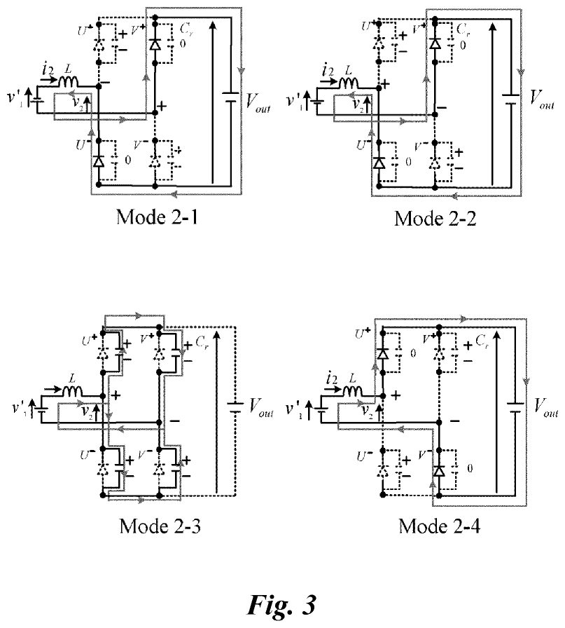

FIG. 3 is a diagram illustrating each commutation operation of the secondary side diode rectification circuit, showing circuit operation in each mode when the diodes U− and V+ are commutated to the diodes U+ and V− respectively in the secondary side diode rectification circuit when the primary voltage is switched from negative to positive by switching of the H-bridge circuit. In <mode 2-1> before commutation in FIG. 3, the primary side switches R− and S+ are conducting, a primary voltage v₁′ becomes an input DC voltage −Vᵢₙ (=−Vₒᵤₜ) and a negative current −Iₙ flows as the secondary current i₂ since the diodes U− and V+ are conducting. The secondary voltage v₂ becomes an output DC voltage −Vₒᵤₜ, and since the primary voltage and the secondary voltage are equal, the secondary current i₂ with the constant value −Iₙ flows. The voltages of the parallel capacitors of the diodes U− and V+ are zero, and the parallel capacitors of the diodes U+ and V− are charged to the output DC voltage Vₒᵤₜ. At time t=t₂ in FIG. 2, when the switch of the H-bridge circuit is switched from R−, S+ to R+, S− and the primary voltage v₁′ is changed from −Vᵢₙ to Vᵢₙ, the mode is shifted to <mode 2-2>. Even when the mode is shifted to <mode 2-2> in FIG. 3, the diodes U− and V+ continue conducting due to continuity of the secondary current by the inductance L. A voltage formula of the secondary circuit in <mode 2-2> is given by the following formula.

$$\begin{matrix}{v}_{1}^{′} = L \frac{{di}_{2}}{dt} - {V}_{out} & ( {t}_{2} \leq t \leq {t}_{3} )\end{matrix} \qquad ( 1 )$$

Here, by substituting the primary voltage v₁′=Vᵢₙ=Vₒᵤₜ and the initial secondary current value i₂(t₂)=−Iₙ in <mode 2-2> into formula (1), a secondary current i₂(t) in <mode 2-2> is obtained by the following formula.

$$\frac{{di}_{2}}{dt} = \frac{2 {V}_{out}}{L} \qquad ( 2 )$$

$${i}_{2} ( t ) = \frac{2 {V}_{out}}{L} ( t - {t}_{2} ) - {I}_{n} \qquad ( 3 )$$

As shown in FIG. 2, in <mode 2-2>, the secondary current i₂(t) increases toward zero with a constant slope. When the secondary current i₂(t) becomes zero at time t=t₃, <mode 2-2> ends. A period T₂=t₃−t₂ in <mode 2-2> is given by formula (3).

$${T}_{2} = {t}_{3} - {t}_{2} = \frac{{LI}_{n}}{2 {V}_{out}} \qquad ( 4 )$$

When the secondary current i₂(t₃)=0 at time t=t₃, all the diodes in the secondary circuit becomes non-conductive, and the mode is shifted to <mode 2-3> in FIG. 3. The initial voltages of the parallel capacitors of the diodes U− and V+ at time t=t₃ when <mode 2-3> starts are both zero and the initial voltages of the parallel capacitors of the diodes U+ and V− are both Vₒᵤₜ. In <mode 2-3>, a resonance circuit is constructed of an inductor L and four capacitors Cᵣ. From symmetry of the circuit, half of the secondary current, i₂/2, flows through each capacitor. A voltage formula in <mode 2-3> is given by the following formula.

$$\begin{matrix}{v}_{1}^{′} = L \frac{{di}_{2}}{dt} + \frac{2}{{C}_{r}} {\int }_{{t}_{3}}^{t} \frac{{i}_{2}}{2} dt - {V}_{out} & ( {t}_{3} \leq t \leq {t}_{4} )\end{matrix} \qquad ( 5 )$$

By substituting the primary voltage v₁′=Vᵢₙ=Vₒᵤₜ and the initial secondary current value i₂(t₃)=0 into formula (5) and solving the formula, the secondary current i₂(t) in <mode 2-3> is obtained by the following formula.

$$\begin{matrix}2 {V}_{out} = L \frac{{di}_{2}}{dt} + \frac{1}{{C}_{r}} {\int }_{{t}_{3}}^{t} {i}_{2} dt \\ {i}_{2} ( t ) = 2 {V}_{out} \sqrt{\frac{{C}_{r}}{L}} sin \frac{t - {t}_{3}}{\sqrt{{LC}_{r}}}\end{matrix} \qquad ( 6 )$$

As the secondary current i₂(t), a current of resonance angular frequency (o (=2(fₒ₌1/√(LCᵣ)) flows. The secondary voltage v₂ is given by the following formula using the secondary current i₂(t) in formula (6).

$$\begin{matrix}{v}_{2} ( t ) = {v}_{1}^{′} ( t ) - L \frac{{di}_{2}}{dt} \\ = {V}_{out} ( 1 - 2 cos \frac{t - {t}_{3}}{\sqrt{{LC}_{r}}} )\end{matrix} \qquad ( 7 )$$

The secondary current i₂ and the secondary voltage V in formulas (6) and (7) have sinusoidal waveforms as shown in FIG. 2. When the secondary current i₂ and the secondary voltage v₂ become Iₙ and Vₒᵤₜ respectively, the voltages of the parallel capacitors of the diodes U+ and V− are also both zero, and <mode 2-3> ends at time t=t₄. In FIG. 2, the phase at time t=t₄ is π/2, and amplitude Iₙ of the secondary current i₂ and the period T₃=t₄−t₃ in <mode 2-3> are given by the following formula from formulas (6) and (7).

$${I}_{n} = 2 {V}_{out} \sqrt{\frac{{C}_{r}}{L}} \qquad ( 8 )$$

$${T}_{3} = {t}_{4} - {t}_{3} = \frac{π}{2} \sqrt{{LC}_{r}} \qquad ( 9 )$$

The secondary current i₂ in <mode 2-2> in formula (3) and the period T₂ in <mode 2-2> in formula (4) are rewritten as shown in the following formulas by substituting formula (8) into the respective formulas.

$${i}_{2} ( t ) = \frac{2 {V}_{out}}{L} ( t - {t}_{2} - \sqrt{{LC}_{r}} ) \qquad ( 10 )$$

$${T}_{2} = \sqrt{{LC}_{r}} \qquad ( 11 )$$

At time t=t₄, when the voltages of the parallel capacitors of the diodes U+ and V− are both zero, the diodes U+ and V− become conductive, and the mode is shifted to <mode 2-4> in FIG. 3. A voltage formula of the secondary circuit in <mode 2-4> is given by the following formula.

$$\begin{matrix}{v}_{1}^{′} = L \frac{{di}_{2}}{dt} + {V}_{out} & ( {t}_{4} \leq t )\end{matrix} \qquad ( 12 )$$

Here, by substituting the primary voltage v₁′=Vᵢₙ=Vₒᵤₜ and an initial secondary current value i₂(t₄)=Iₙ in <mode 2-4> into formula (12), the secondary current i₂(t) in <mode 2-4> is obtained by the following formula.

$$\begin{matrix}\frac{{di}_{2}}{dt} = 0 \\ {i}_{2} ( t ) = In = 2 {V}_{out} \sqrt{\frac{{C}_{r}}{L}}\end{matrix} \qquad ( 13 )$$

As shown in FIG. 2, in <mode 2-4>, the secondary current i₂(t) becomes a constant value. When the H-bridge circuit is switched and the primary voltage is switched from positive to negative, <mode 2-4> ends.

Each diode is switched from the operation of the secondary circuit in a state in which each parallel capacitor voltage is zero. That is, since no diode recovery loss is generated, no power loss is generated, resulting in extremely high efficiency. The output power Pout can be obtained by the following formula using an output current iₒᵤₜ as average power of the half cycle Tₛ of the high-frequency transformer.

$$\begin{matrix}{P}_{out} = \frac{1}{{T}_{s}} {\int }_{{t}_{2}}^{{t}_{2} + {T}_{s}} {V}_{out} {i}_{out} dt \\ = {V}_{out} {I}_{n} ( 1 - \frac{1 + π}{2 {T}_{s}} \sqrt{{LC}_{r}} ) \\ = 2 {V}_{out}^{2} \sqrt{\frac{{C}_{r}}{L}} ( 1 - \frac{1 + π}{2 {T}_{s}} \sqrt{{LC}_{r}} )\end{matrix} \qquad ( 14 )$$

Control of the output power Pot can be adjusted by the frequency fₛ of the high-frequency transformer. By rewriting the output power Pₒᵤₜ in formula (14) using the frequency fₛ (=1/2 Tₛ) and the resonance frequency fₒ (=1/(2π√(LCᵣ))) of the high-frequency transformer, the following formula is obtained.

$${P}_{out} = 2 {V}_{out}^{2} \sqrt{\frac{{C}_{r}}{L}} \{ 1 - ( \frac{1}{2} + \frac{1}{2 π} ) \frac{{f}_{s}}{{f}_{o}} \} \qquad ( 15 )$$

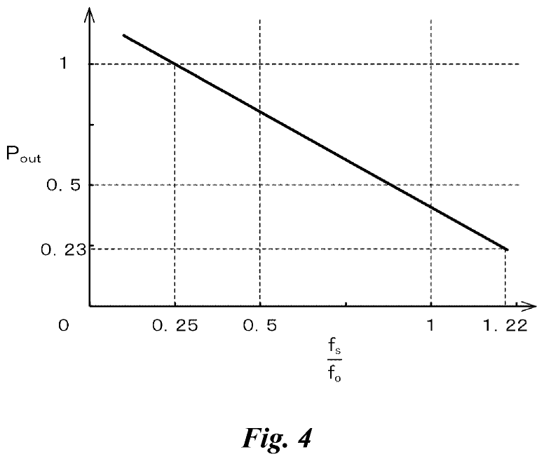

FIG. 4 illustrates characteristics of the output power Pₒᵤₜ versus a ratio fₛ/fₒ of the frequency of the high-frequency transformer to a resonance frequency based on formula (14). The resonance frequency fₒ is determined by a circuit parameter, is a constant value, and the output power Pₒᵤₜ can be reduced by increasing the frequency fₛ, of the transformer. In FIG. 4, at the ratio of the frequency of the high-frequency transformer to the resonance frequency (fₛ/fₒ)=1/4, a rated output Pₒᵤₜ is normalized to 1. A maximum frequency (fₛ/fₒ)max of the high-frequency transformer at which the output power Pₒᵤₜ in formula (14) holds corresponds to a case where the period of the current value Iₙ in the waveform of the secondary current i₂(t) in FIG. 2 becomes zero, and can be obtained by the following formula.

$${( \frac{{f}_{s}}{{f}_{o}} )}_{max} = \frac{2 π \sqrt{{LC}_{r}}}{2 ( 1 + π / 2 ) \sqrt{{LC}_{r}}} = \frac{2 π}{2 + π} = 1.22 \qquad ( 16 )$$

The maximum frequency of the high-frequency transformer becomes (fₛ/fₒ)max=1.22 and in this case, the output power can be reduced down to 0.23 of the rated output in FIG. 4. If the frequency fₛ of the high-frequency transformer is set to a frequency higher than a value determined from the(fₛ/fₒ)max, formula (14) does not hold, but the output power Pₒᵤₜ can further be reduced.

Next, soft switching commutation of the H-bridge circuit will be described.

Although it has been described in FIG. 1 that the parallel capacitor Cₛ of the switching element of the primary side H-bridge circuit is a parasitic capacitance, capacitors may be separately and externally attached in parallel to realize soft switching of the switch. Hereinafter, including a case where capacitors are externally attached in parallel, the parallel capacitance of the switching element will be described as Cₛ.

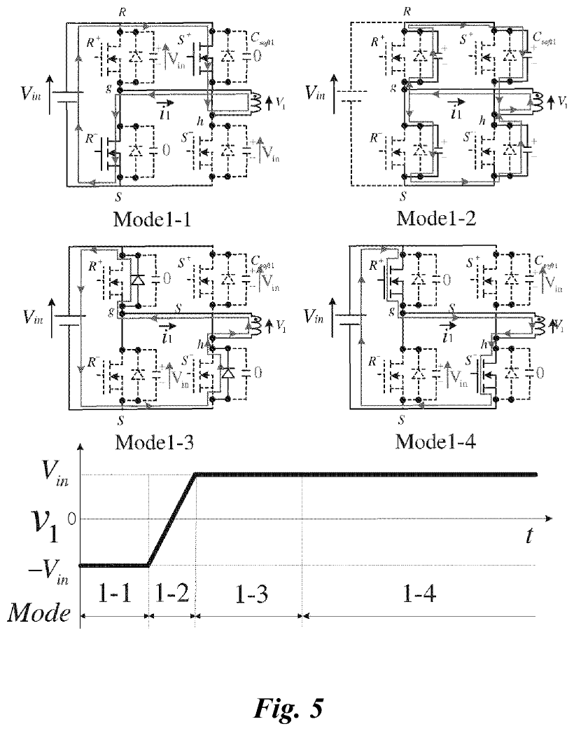

FIG. 5 illustrates operating modes of the primary side H-bridge circuit and the primary voltage waveform v₁ of the high-frequency transformer when the switch R−, S+ is commutated to the switch R+, S− of the circuit.

In <mode 1-1> before commutation, the switches R− and S+ are both conducting, and a negative input DC voltage −Vᵢₙ is generated as the primary voltage v₁. As the primary current i₁, a negative constant current −Iₙ flows through the switches R− and S+. The voltages of the parallel capacitors of the switches R− and S+ are both zero and the voltages of the parallel capacitors of the switches R+ and S− are both charged to the input DC voltage Vᵢₙ. When the switches R− and S+ are set to non-conducting state, since the parallel capacitor voltages are zero, the switches R− and S+ are subjected to zero voltage switching (ZVS).

By setting the switches R− and S+ to the non-conducting state, the mode is shifted to <mode 1-2> in FIG. 5. In <mode 1-2>, from the continuity of the load current, the primary current i₁ is kept at the negative current −Iₙ and flows to the four parallel capacitors Cs. The voltages of the parallel capacitors of the switches R− and S+ increase from zero and the voltages of the parallel capacitors of the switches R+ and S− decrease. Due to the changes in the capacitor voltages, the primary voltage v₁ changes from the negative input DC voltage −Vᵢₙ to a positive input DC voltage Vᵢₙ. When the primary voltage v₁ becomes the positive input DC voltage Vᵢₙ, the parallel capacitor voltages of the switches R+ and S− become both zero and the parallel diodes of the switches R+ and S− are brought into conduction. The conduction of the parallel diodes of the switches R+ and S− causes the mode to be shifted to <mode 1-3>. During the period in <mode 1-3>, a gate signal is given to bring the switches R+ and S− into conduction. Since the parallel diodes are in a conducting state, even if a gate signal is given to the switches, the switches are reverse-biased and are not brought into conduction. As already mentioned, the primary current i₁ increases toward zero with a constant slope. When the primary current i₁ turns positive from negative, the mode is shifted to <mode 1-4>. When the sign of the primary current i₁ changes from negative to positive and the switches R+ and S− are brought into conduction, the parallel capacitor voltages remain zero, making it possible to realize ZVS. Soft switching can also be realized likewise for other switching, making it possible to reduce switching losses.

As described above, according to the first embodiment, it is possible to obtain an effect of reducing switching losses efficiently with a simple circuit configuration.

As a further effect, power control on the output side can be easily performed, and in particular, controllability on the low output side improves. As described above, according to formula (14), although the power on the output side can be adjusted by a switching frequency, controllability when the Pₒᵤₜ value is equal to or less than 0.23 deteriorates and a slight frequency fluctuation may cause a considerable change in the output. According to the first embodiment, however, it is possible to control the power on the output side regardless of formula (14). As a result, it is also possible to control the power supply to an extremely small level after the charging level of an output power supply target, such as a battery, exceeds a certain value. A specific method thereof will be described in detail in a third embodiment.

### Second Embodiment—Circuit Configuration with Primary Side Half Bridge Circuit

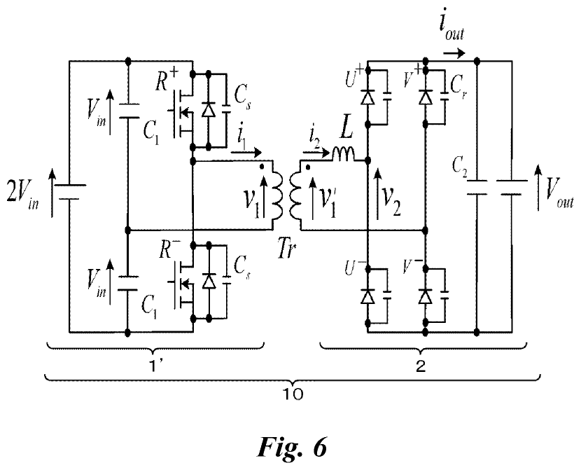

FIG. 6 illustrates a circuit in which the primary side H-bridge circuit in FIG. 1 according to the first embodiment is replaced with a half bridge circuit (1′). An input DC voltage is 2Vᵢₙ and two capacitors C1 are connected in series to provide a DC neutral point of the input DC voltage 2Vᵢₙ. The DC voltages of the two capacitors C1 are both Vᵢₙ. One of the two input terminals of the high-frequency transformer is connected to an R-phase output terminal and the other is connected to the DC neutral point. The half bridge is constructed of two switching elements R+ and R−. Each switching element incorporates an antiparallel diode and a parasitic capacitance of the switching element is Cₛ.

The operating waveform of the insulated DC-DC power conversion circuit using the H-bridge circuit shown in FIG. 2 is applicable as it is, as an operating waveform of the circuit using the half bridge circuit in FIG. 6 if the S-phase switching signal is ignored. That is, by bringing the switching element R+ into conduction, the primary voltage v₁ of the high-frequency transformer is connected to the upper capacitor C1 of the input DC voltage and becomes the capacitor voltage Vᵢₙ. By bringing the switching element R− into conduction, the primary voltage v₁ of the high-frequency transformer is connected to the lower capacitor C1 of the input DC voltage and becomes the negative capacitor voltage −Vᵢₙ.

Therefore, as in the case of using the H-bridge circuit, a square wave AC waveform of amplitude Vᵢₙ can be obtained as the primary voltage v₁. The high-frequency transformer and the secondary circuit in the circuit using the half bridge circuit is the same as the circuit using the H-bridge circuit in FIG. 1, and the respective waveforms of the secondary voltage v₂, the primary current i₁ and the secondary current i₂ in FIG. 2 are obtained. The secondary circuit can operate highly efficiently without diode recovery losses.

As described in the first embodiment, the control of the output power Pₒᵤₜ can be adjusted by the frequency fₛ (=1/2 Tₛ) of the high-frequency transformer according to formula (15). Furthermore, soft switching of the primary side half bridge circuit can also be realized.

Commutation from the switch R− to the switch R+ in the half bridge circuit in FIG. 6 will be described. While the switch R− is in a conducting state, the primary voltage v₁ is a negative input DC voltage −Vᵢₙ and a negative current −Iₙ flows through the switch R− as the primary current i₁. The voltage of the parallel capacitor of the switch R− is zero. When the switch R− is set to non-conducting state, the voltage of the parallel capacitor of the switch R− is zero and ZVS is realized. When the negative current −Iₙ flows following the primary current i₁, the voltage of the parallel capacitor of the switch R+ decreases from Vᵢₙ, and when the voltage becomes zero voltage, the parallel diode of the switch R+ becomes conductive. The primary voltage v₁ becomes a positive input DC voltage Vᵢₙ and the primary current i₁ also increases toward zero from the negative current −Iₙ. While the primary current i₁ is negative, if a conduction signal is given to the switch R+, the primary current i₁ changes from negative to positive, and even when a current is commutated from the diode to the switch R+, the voltage of the parallel capacitor is zero and ZVS is realized. Therefore, it is possible to realize soft switching in all commutations and reduce switching losses.

The secondary circuit shown in the present embodiment is the same as the one in the first embodiment and is characterized by the use of resonance between an inductance L and a capacitance Cᵣ. Therefore, other configurations can be changed as appropriate depending on the application. For example, although a DC power supply is connected to the secondary side output in FIG. 6, a DC load may be connected. For example, for an application such as a charging circuit of a secondary battery, it is represented as a DC power supply as shown in FIG. 6, but when it is used as a DC-DC converter, for example, when power is converted, for example, from overhead rail lines to railroad, it is represented as a DC load.

As described above, a DC-DC power converter can be configured even when a half bridge circuit is used as the primary circuit. According to the second embodiment, the configuration of the primary circuit is simpler than the first embodiment and it is possible to obtain a much smaller or lower-cost DC-DC power converter. Note that control of the power on the output side can be adjusted by switching frequency according to formula (15).

### Third Embodiment—Method for Controlling Transmission Power by Controlling Ta

As described in the first and second embodiments above, power of the secondary circuit can be controlled by changing the switching frequency of the primary circuit according to formula (14) in all the circuit configurations. However, according to the circuit configuration described in the first embodiment, since the period Td during which the primary voltage v₁ is zero can be controlled, the secondary power can be controlled regardless of frequency control.

In the present embodiment, a power control method realized by controlling the period T_{d} during which the primary voltage v₁ is zero in the circuit described in the first embodiment will be described.

(1) Power Reduction Control Method in <Mode 2-2>

A method for controlling output power Pₒᵤₜ by a switching pattern of a primary side H-bridge circuit when the frequency fₛ of the high-frequency transformer of the unidirectional insulated DC-DC power conversion circuit in FIG. 1 is a constant value will be described.

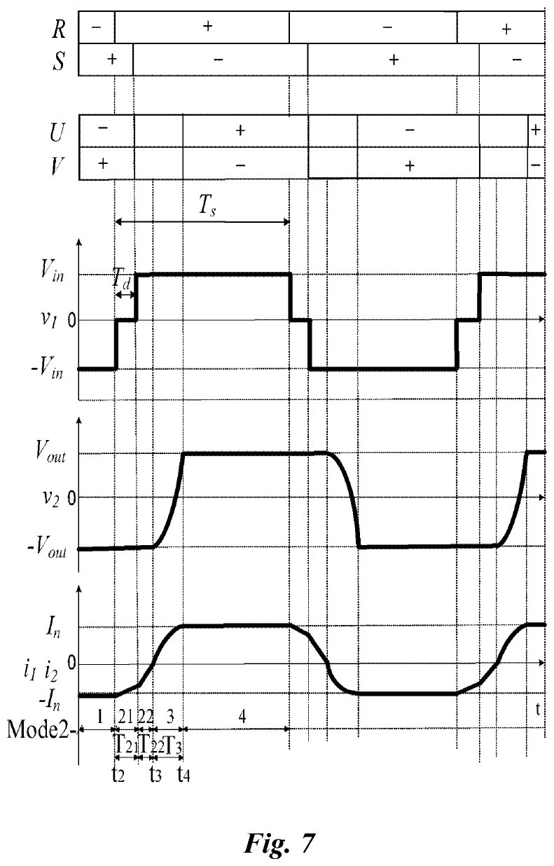

FIG. 2 illustrates the operating waveform at maximum output power, and a square wave AC waveform of amplitude Vᵢₙ is outputted as the primary voltage v₁. FIG. 7 illustrates the operating waveform in the case where power is slightly reduced to adjust the output power Pₒᵤₜ. A basic conception of power reduction is a method of reducing an effective value of the primary voltage v₁ by delaying switching timing of the S-phase switch by a period Td and providing the period T_{d} during which the voltage is zero in the square wave waveform of the primary voltage v₁. In the operating waveform in FIG. 7, a new mode has only been added to the period T_{d} during which the primary voltage v₁ is zero and waveforms other than the period T_{d} are the same as the waveform at the time of maximum output power in FIG. 2. In the operating waveform in FIG. 7, the waveform is separated into two modes assuming that the period T_{d} during which the primary voltage v₁ is zero is <mode 2-21> and the period during which the primary voltage v₁ is Vᵢₙ is <mode 2-22>. By substituting a primary voltage v₁′=0, an initial secondary current value i₂(t₂)=−Iₙ and formula (8) into the secondary circuit voltage formula in <mode 2-2> in formula (1), a secondary current i₂(t) in <mode 2-21> is obtained by the following formula.

$$\frac{{di}_{2}}{dt} = \frac{{V}_{out}}{L} \qquad ( 17 )$$

$$\begin{matrix}{i}_{2} ( t ) = \frac{{V}_{out}}{L} ( t - {t}_{2} - 2 \sqrt{{LC}_{r}} ) & ( {t}_{2} \leq t \leq {t}_{2} + {T}_{d} )\end{matrix} \qquad ( 18 )$$

That is, since a slope di₂/dt of the secondary current in <mode 2-21> in formula (17) is ½ of the slope in <mode 2-2> in formula (2), the maximum period T_{d} in <mode 2-21> is two times the period T₂=√(LCᵣ) in <mode 2-2>. Therefore, a range of a period T₂₁=T_{d} in <mode 2-21> is given by the following formula.

0≤T₂₁≤2\sqrt{LCᵣ}> (19)

Here, by substituting time t=t₂+T_{d} into formula (18), an initial secondary current value i₂(t₂+T_{d}) in <mode 2-22> is obtained by the following formula.

$${i}_{2} ( {t}_{2} + {T}_{d} ) = \frac{{V}_{out}}{L} ( {T}_{d} - 2 \sqrt{{LC}_{r}} ) \qquad ( 20 )$$

By substituting the primary voltage v₁′=Vᵢₙ=Vₒᵤₜ, the initial secondary current value i₂(t₂+T_{d}) in formula (20) and formula (8) into the secondary circuit voltage formula in <mode 2-2> in formula (1), a secondary current i₂(t) in <mode 2-22> is obtained by the following formula.

$$\begin{matrix}{i}_{2} ( t ) = \frac{2 {V}_{out}}{L} ( t - {t}_{2} - \frac{{T}_{d}}{2} - \sqrt{{LC}_{r}} ) & ( {t}_{2} + {T}_{d} \leq t \leq {t}_{3} )\end{matrix} \qquad ( 21 )$$

At end time t₃ in <mode 2-22>, since the secondary current i₂(t₃)=0 in formula (21), the end time t₃ and period T₂₂ in <mode 2-22> are obtained by the following formulas.

$${t}_{3} = {t}_{2} + \sqrt{{LC}_{r}} + \frac{{T}_{d}}{2} \qquad ( 22 )$$

$${T}_{22} = {t}_{3} - ( {t}_{2} + {T}_{d} ) = \sqrt{{LC}_{r}} - \frac{{T}_{d}}{2} \qquad ( 23 )$$

By calculating the output power Pₒᵤₜ based on the derived secondary current waveforms in all modes, the following formulas are obtained and the output power Pₒᵤₜ can be controlled by the period T_{d} during which the primary voltage v₁ is zero.

$$\begin{matrix}{P}_{out} = {V}_{out}^{2} \{ 2 \sqrt{\frac{{C}_{r}}{L}} ( 1 - \frac{1 + π}{2 {T}_{s}} \sqrt{{LC}_{r}} ) - \frac{{T}_{d}^{2}}{4 {LT}_{s}} \} \\ = 2 {V}_{out}^{2} \sqrt{\frac{{C}_{r}}{L}} ( 1 - \frac{1 + π}{2 {T}_{s}} \sqrt{{LC}_{r}} - \frac{{T}_{d}^{2}}{8 {T}_{s} \sqrt{{LC}_{r}}} ) \\ \end{matrix} \qquad ( 24 )$$

(2) Power Reduction Control Method in <Mode 2-3>

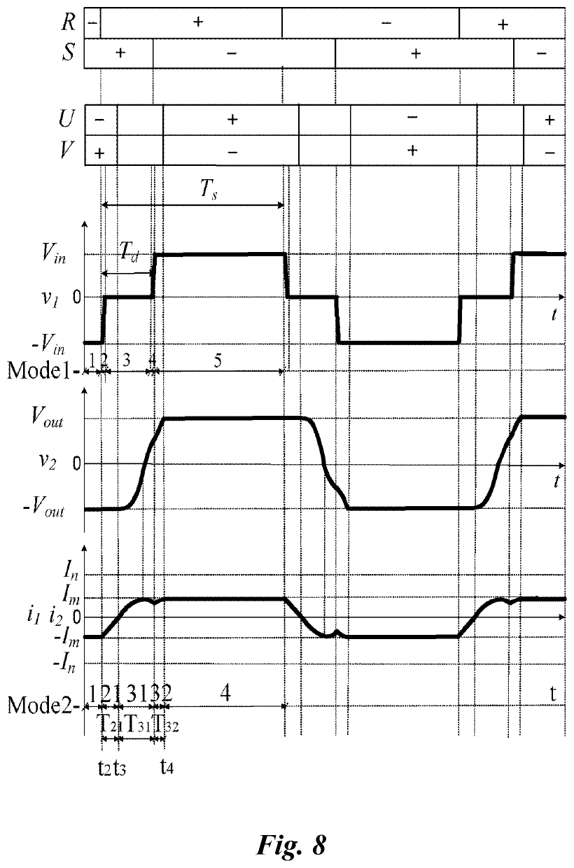

When the period T_{d} during which the primary voltage v₁ is zero reaches or exceeds 2 √(LCᵣ), the primary voltage v₁ is zero until the range of <mode 2-3> in FIG. 7, and the resonance waveform of the secondary current i₂ in formula (6) changes. FIG. 8 illustrates respective waveforms of the secondary voltage v₂, the primary current i₁ and the secondary current i₂ when the period T_{d} during which the primary voltage v₁ is zero reaches or exceeds 2 (LCᵣ). The operating waveforms in FIG. 8 are divided, between times t₃ and t₄, into two modes: <mode 2-31> as a period T₃₁ during which the primary voltage v₁ is zero and <mode 2-32> as a period T₃₂ during which the primary voltage v₁ is Vᵢₙ. An absolute value Iₘ of a current value −Iₘ of the secondary current i₂ in <mode 2-1> is smaller than Iₙ(> Iₘ) in formula (8).

<Mode 2-1> in FIG. 8 corresponds to the circuit connection in <mode 2-1> before commutation in FIG. 3, the primary switches R− and S+ are brought into conduction, the input DC voltage −Vᵢₙ is applied as the primary voltage v₁′, and the diodes U− and V+ are brought into conduction and a negative current −Iₘ flows as the secondary current i₂. At time t=t₂ in FIG. 8, when the switch of the H-bridge circuit is switched from R− to R+ and the primary voltage v₁′ changes from −Vᵢₙ to 0, the mode is shifted to <mode 2-21>. By substituting the primary voltage v₁′=Vᵢₙ=Vₒᵤₜ and the initial secondary current value i₂(t₂)=−Iₘ in <mode 2-21> into formula (1), the secondary current i₂(t) in <mode 2-21> is obtained by the following formulas.

$$\frac{{di}_{2}}{dt} = \frac{{V}_{out}}{L} \qquad ( 25 )$$

$${i}_{2} ( t ) = \frac{{V}_{out}}{L} ( t - {t}_{2} ) - {I}_{m} \qquad ( 26 )$$

As shown in FIG. 8, in <mode 2-21>, the secondary current i₂(t) increases toward zero with a constant slope. When the secondary current i₂(t) becomes zero at time t=t₃, <mode 2-21> ends. The period T₂₁=t₃−t₂ in <mode 2-21> is given by formula (27).

$${T}_{21} = {t}_{3} - {t}_{2} = \frac{{LI}_{m}}{{V}_{out}} \qquad ( 27 )$$

When the secondary current i₂(t₃)=0 at time t=t₃, all the diodes in the secondary circuit are placed in a non-conducting state, and the mode is shifted to <mode 2-31> in FIG. 3. At time t=t₃ when <mode 2-31> starts, the initial voltages of the parallel capacitors of the diodes U− and V+ are both zero and the initial voltages of the parallel capacitors of the diodes U+ and V− are both Vₒᵤₜ. In <mode 2-3>, a resonance circuit with an inductor L and four capacitors Cᵣ is configured. Due to the symmetry of the circuit, a current i₂/2, half the secondary current, flows to each capacitor and the voltage formula in formula (5) holds. By substituting the primary voltage v₁′=0 and the initial secondary current value i₂(t₃)=0 into formula (5) and solving the formula, the secondary current i₂(t) in <mode 2-31> is obtained by the following formula.

$${V}_{out} = \frac{{di}_{2}}{dt} + \frac{1}{{C}_{r}} {\int }_{{t}_{3}}^{t} {i}_{2} dt \\ \begin{matrix}{i}_{2} ( t ) = {V}_{out} \sqrt{\frac{{C}_{r}}{L}} sin \frac{t - {t}_{3}}{\sqrt{{LC}_{r}}} & ( {t}_{3} \leq t \leq {t}_{3} + {T}_{31} )\end{matrix} \qquad ( 28 )$$

The secondary voltage v₂ is obtained by the following formula using the secondary current i₂(t) in formula (28).

$${v}_{2} ( t ) = {v}_{1}^{′} ( t ) - L \frac{{di}_{2}}{dt} = {V}_{out} cos \frac{t - {t}_{3}}{\sqrt{{LC}_{r}}} \qquad ( 29 )$$

The secondary current i₂ and the secondary voltage v₂ in formulas (28) and (29) have sinusoidal waveforms as shown in FIG. 8. The secondary voltage v₂ and the secondary voltage v₂ at time t=t₃+T₃₁ are obtained by the following formula.

$${i}_{2} ( {t}_{3} + {T}_{31} ) = {V}_{out} \sqrt{\frac{{C}_{r}}{L}} sin \frac{{T}_{31}}{\sqrt{{LC}_{r}}} \qquad ( 30 )$$

$${v}_{2} ( {t}_{3} + {T}_{31} ) = - {V}_{out} cos \frac{{T}_{31}}{\sqrt{{LC}_{r}}} \qquad ( 31 )$$

When the switch of the H-bridge circuit is switched from S+ to S− at time t=t₃+T₃₁, the primary voltage v₁=Vᵢₙ increases stepwise, resulting in a new resonance operation. The voltage formula in <mode 2-32> is given by the following formula.

$${v}_{1}^{′} = L \frac{{di}_{2}}{dt} + \frac{2}{{C}_{r}} {\int }_{{t}_{3}}^{t} \frac{{i}_{2}}{2} dt - {v}_{2} ( {t}_{3} + {T}_{31} ) \\ ( {t}_{3} + {T}_{31} \leq t \leq {t}_{4} ) \qquad ( 32 )$$

By substituting the primary voltage v₁′=Vᵢₙ=Vₒᵤₜ and the initial secondary current value i₂(t₃+T₃₁) into formula (32) and solving the formula, the secondary current i₂(t) in <mode 2-32> is obtained by the following formula.

$${i}_{2} ( t ) = {V}_{out} \sqrt{\frac{{C}_{r}}{L}} \{ sin \frac{i - {i}_{3} - {T}_{31}}{\sqrt{{LC}_{r}}} + sin ( \frac{t - {t}_{3} - {T}_{31}}{\sqrt{{LC}_{r}}} + \frac{{T}_{31}}{\sqrt{{LC}_{r}}} ) \} = 2 {V}_{out} \sqrt{\frac{{C}_{r}}{L}} cos \frac{{T}_{31}}{2 \sqrt{{LC}_{r}}} sin ( \frac{t - {t}_{3}}{\sqrt{{LC}_{r}}} + \frac{{T}_{31}}{2 \sqrt{{LC}_{r}}} ) \qquad ( 33 )$$

The term of the first line in formula (33) is a resonance current generated by a change to the primary voltage v₁′=Vₒᵤₜ at time t=t₃+T₃₁ and the term of the second line is the resonance current term from time t=t₃+T₃₁ or earlier. The third line is a formula expressing these two terms as one resonance current. The secondary voltage v₂ in <mode 2-32> is obtained by the following formula using the secondary current i₂(t) in formula (33).

$${v}_{2} ( t ) = {v}_{1}^{′} ( t ) - L \frac{{di}_{2}}{dt} = {V}_{out} \{ 1 - 2 cos \frac{{T}_{31}}{2 \sqrt{{LC}_{r}}} cos ( \frac{t - {t}_{3}}{\sqrt{{LC}_{r}}} + \frac{{T}_{31}}{2 \sqrt{{LC}_{r}}} ) \} \qquad ( 34 )$$

When the secondary voltage v₂(t₄)=Vₒᵤₜ at time t=t₄, the voltages of the parallel capacitors of the diodes U+ and V− become zero, the diodes U+ and V− are brought into conduction and <mode 2-32> ends. The second term of formula (34) becomes zero at time t=t₄, and since it is possible to express a period t₄−t₃=T₃₁+T₃₂ using the period T₃₂ in <mode 2-32>, the period T₃₂ is obtained by the following formula.

$$\frac{{T}_{31} + {T}_{32}}{\sqrt{{LC}_{r}}} + \frac{{T}_{31}}{2 \sqrt{{LC}_{r}}} = \frac{π}{2} \qquad ( 35 )$$

$${T}_{32} = \frac{- 3 {T}_{31} + π \sqrt{{LC}_{r}}}{2}$$

Time t=t₄ can be given by the following formula as a function of the period T₃₁ using formula (35).

$${t}_{1} = {t}_{3} + {T}_{31} + {T}_{32} = {t}_{3} + \frac{- {T}_{31} + π \sqrt{{LC}_{r}}}{2} \qquad ( 36 )$$

By substituting t₄ in formula (36) into formula (33), a secondary current i₂(t₄)=Iₘ is obtained by the following formula.

$${i}_{2} ( {l}_{4} ) = {I}_{m} = 2 {V}_{out} \sqrt{\frac{{C}_{r}}{L}} cos \frac{{T}_{31}}{2 \sqrt{{LC}_{r}}} \qquad ( 37 )$$

As the period T₃₁ gets longer, the secondary current value Iₘ gets smaller, and transmission power can be reduced. Since the secondary current value Iₘ=0 when the period T₃₁=π√(LCᵣ), the period T₃₁ may be controlled in a range from zero to π√(LCᵣ).

During a period t>t₄ in <mode 2-4>, the voltage formula in formula (12) holds and di₂/dt=0 from the primary voltage v₁′=Vᵢₙ=Vₒᵤₜ, and the secondary current i₂(t₄)=Iₘ of a constant value flows.

By substituting Iₘ in formula (37) into formula (27), the period T₂₁ is obtained by the following formula.

$${T}_{21} = 2 \sqrt{{LC}_{r}} cos \frac{{T}_{31}}{2 \sqrt{{LC}_{r}}} \qquad ( 38 )$$

The period T_{d} during which the primary voltage is zero is obtained by the following formula using the period T₃₁.

$${T}_{d} = {T}_{21} + {T}_{31} = {T}_{31} + 2 \sqrt{{LC}_{r}} cos \frac{{T}_{31}}{2 \sqrt{{LC}_{r}}} \qquad ( 39 )$$

A maximum value T_{d max} of the period during which the primary voltage is zero at the time of a maximum value v₁(LCᵣ) of the period T₃₁ is obtained by the following formula.

T_{dmax}=π\sqrt{LCᵣ} (40)

From the secondary voltage v₂ and the secondary current i₂ in FIG. 8, the output power Pₒᵤₜ of the period Tₛ is expressed by the following formula.

$${P}_{out} = {V}_{out} {I}_{m} ( 1 - \frac{{T}_{31} + {T}_{32} + {T}_{21} / 2}{{T}_{s}} ) \qquad ( 41 )$$

By substituting Iₘ in formula (37), T₃₂ in formula (35) and T₂₁ in formula (38) into formula (41), the output power Pₒᵤₜ can be expressed by the following formula.

$${P}_{out} = 2 V \text{?} \sqrt{\frac{{C}_{r}}{L}} \text{?} \frac{\text{?}}{2 \sqrt{{LC}_{r}}} [ 1 - \frac{1}{\text{?}} \text{?} + \sqrt{{LC}_{r}} ( π + 2 cos \frac{\text{?}}{2 \sqrt{{LC}_{r}}} ) \} ] \qquad ( 42 )$$

$$\text{?} \text{indicates text missing or illegible when filed}$$

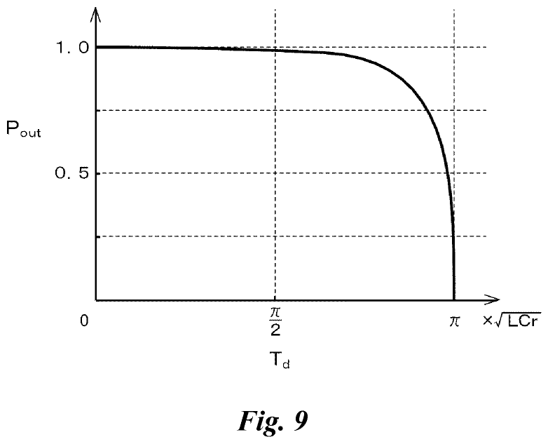

FIG. 9 illustrates the output power Pₒᵤₜ in formula (42) versus the period T_{d} during which the primary voltage in formula (39) is zero. FIG. 9 shows a case where the ratio of the frequency of the high-frequency transformer to the resonance frequency: fₛ/fₒ=π√(LCᵣ)/Tₛ=¼, where Tₛ=4π√(LCᵣ). As the period T_{d} during which the primary voltage is zero increases, the secondary current value Iₘ decreases, and the output power Pₒᵤₜ also decreases. Therefore, the output power Pₒᵤₜ can be controlled by the period T_{d} during which the primary voltage is zero.

Although a case has been described above where the turn ratio of the high-frequency transformer a=1, and further, input and output DC voltages are equal, Vᵢₙ=Vₒᵤₜ, similar operating waveforms can be obtained also when input and output DC voltages have a relationship of Vᵢₙ/a=Vₒᵤₜ. Iₙ the case where input and output DC voltages have a relationship of Vᵢₙ/a=Vₒᵤₜ, there may be a case where, when the secondary current waveform has a constant value according to the above description, an error may occur: a slope is generated in the secondary current waveform due to a difference between the primary and secondary voltages, but the aforementioned basic functions can be obtained likewise.

### Fourth Embodiment—Output Power Control and Separation of Primary Circuit from Secondary Circuit

Iₙ the circuit configurations of the present disclosure in FIG. 1 and FIG. 6, since both secondary circuits are constructed of passive elements, the secondary circuits need not be controlled. Therefore, it is possible to detect the DC voltage Vᵢₙ and the primary current i₁ of the primary circuit and control the output power Pₒᵤₜ by the frequency fₛ of the primary circuit or the zero-voltage period T_{d}. Furthermore, the primary circuit and the secondary circuit can be physically separated if the primary and secondary circuits are made separable by the primary and secondary wiring cores of the high-frequency transformer. The primary circuit and the secondary circuit can be used in combination only for power transmission.

For example, power transmission (charging) is possible by placing the primary circuit, which is the power supply side, on the ground side and the secondary circuit on the vehicle side and bringing the primary and secondary iron cores of the high-frequency transformer closer to each other only when transmitting power (charging the vehicle). Except during power transmission, the cores of the transformer are physically separated (made independent), whereas during power transmission (charging), the primary and secondary cores can be coupled by an electromagnetic power acting between the cores and thus power transmission is possible. Thus, the present disclosure is also applicable to such non-radiating coupled magnetic field contactless power transmission.

### INDUSTRIAL APPLICABILITY

The power converter according to the present disclosure can be widely used in all product areas such as secondary battery chargers, railroad and other industrial equipment depending on power to be transmitted, providing a wide range of applications and extremely large industrial applicability.

### REFERENCE SIGNS LIST

10 power converter
1 primary circuit (H-bridge circuit)
1′ primary circuit (half bridge circuit)
2 secondary circuit
C1 capacitor
C2 (smoothing) capacitor
Cᵣ resonance capacitor
Cₛ parasitic capacitance
U+, U−, V+, V− diode
R+, R−, S+, S− switching element
Tr transformer
L inductance

1. A power converter comprising a primary circuit and a secondary circuit connected via a transformer, wherein
the primary circuit comprises a circuit having a switching element,
the secondary circuit comprises a diode rectification circuit including four diodes each having a resonance capacitor connected in parallel, and a smoothing capacitor connected in parallel, and
in the secondary circuit, a resonance circuit is formed by a leakage inductance of the transformer and the resonance capacitor.

2. The power converter according to claim 1, wherein
the primary circuit comprises a capacitor and an H-bridge circuit connected in parallel, and
the H-bridge circuit comprises the four switching elements.

3. The power converter according to claim 1, wherein
in the primary circuit, both ends of two capacitors connected in series to input and a half bridge circuit are connected in parallel,
the half bridge circuit comprises the two switching elements connected in series, and
a DC neutral point between the two capacitors and a DC neutral point between the two switching elements are connected to the primary side of the transformer.

4. The power converter according to claim 1, wherein the switching element realizes soft switching using any one or both of a parasitic capacitance of the switching element and a capacitor connected in parallel to the switching element.

5. The power converter according to claim 1, wherein an core of the transformer is configured to be made separable into a primary circuit and a secondary circuit.

6. A power control method for the power converter according to claim 1, comprising inputting a control signal for generating a square wave voltage in the soft switching circuit.

7. A power control method for the power converter according to claim 1, comprising adjusting output power of the secondary circuit by controlling a frequency of the square wave voltage.

8. A power control method for the power converter according to claim 2, comprising controlling a period T_{d} during which the voltage of the primary terminal of the transformer is zero to thereby adjust output power of the secondary circuit without changing the frequency of the soft switching circuit.
